(19) United States
(12) Patent Application Publication
(10) Pub. No.: US 2017/0301434 A1
(43) Pub. Date: Oct. 19, 2017

(54) METHODS FOR MANUFACTURING AN INSULATED BUSBAR

(71) Applicant: LITTELFUSE, INC., Chicago, IL (US)

(72) Inventors: Jianhua Chen, Sunnyvale, CA (US); Chun-Kwan Tsang, Morgan Hill, CA (US)

(73) Assignee: LITTELFUSE, INC., Chicago, IL (US)

(21) Appl. No.: 15/131,191

(22) Filed: Apr. 18, 2016

(51) Int. Cl. H01B 13/16; H01B 13/00; H01B 3/30; H01B 1/02; H01B 3/40; H01B 3/42; H01B 3/44

(52) U.S. Cl. CPC H01B 13/16; H01B 3/30; H01B 13/0016; H01B 1/02; H01B 3/302; H01B 3/421; H01B 3/447; H01B 3/40

(57) ABSTRACT

A method for manufacturing an insulated conductive material includes applying a masking material to one or more regions of a conductive material. Regions of the conductive material other than the masked regions are coated. The regions are coated by electrically charging the conductive material with a first charge polarity, providing a medium of electrically charged insulating material particles that are charged with an opposite polarity, and passing the charged conductive material through the medium, whereby the insulating material particles bind areas of the conductive material and form an insulating film on areas of the surface other than the one or more regions. Afterwards, the insulating film is cured and a solvent is applied to the masking material to thereby remove the masking material. The cured insulated material film is substantially unaffected by the solvent.

### BACKGROUND

### Field

The present invention relates generally to insulated conductors. More specifically, the present invention relates to methods for manufacturing insulating busbars.

### Description of Related Art

A typical mobile device may utilize two or more battery cells to provide power to the mobile device. The batteries may be connected in series or parallel configurations via so-called busbars, which typically correspond to one or more strips of conductive material suitably sized to handle the required amount of current.

Insulation of the busbar is usually required to prevent a short circuit condition between the busbar and other electrical components of the mobile device. One method for manufacturing an insulated busbar includes cutting a length of a conductive material to a desired length and cutting two portions of an insulating material to the same length. For example, the respective components may be cut to a length of 20 cm. The respective portions of insulating material are placed on the top and bottom surfaces of the conductive material, respectively, to insulate the conductive material, and thereby provide an insulated busbar. In subsequent operations, portions of the insulating material may be removed to expose the conductive material to facilitate making an electrical connection with the busbar.

Typical methods for removing the insulating material to expose the conductive material require that the portion being removed be on an outward-facing surface. This is the case, for example, when using laser and/or mechanical means to remove the insulating portion because the methods may require direct line of sight to the portion being removed. However, when the insulating portion to be removed is on an inward-facing surface, use of these methods to remove the insulating material may be impractical.

Other problems with existing methods for manufacturing insulated busbars will become apparent in view of the disclosure below.

### SUMMARY

In one aspect, a method for manufacturing an insulated conductive material includes applying a masking material to one or more regions of a conductive material. Regions of the conductive material other than the masked regions are coated. The regions are coated by electrically charging the conductive material with a first charge polarity, providing a medium of electrically charged insulating material particles that are charged with an opposite polarity, and passing the charged conductive material through the medium, whereby the insulating material particles bind to areas of the conductive material and form an insulating film on the surface other than the one or more regions. Afterwards, the insulating material film is cured and a solvent is applied to the masking material to thereby remove the masking material. The cured insulated material film is substantially unaffected by the solvent.

In a second aspect, a busbar includes a conductive material and an insulating material that covers first portions of the conductive material. Other portions of the conductive material are exposed. The insulating material is formed on the conductive material by the process described above.

### BRIEF DESCRIPTION OF THE DRAWINGS

FIG. 1 illustrates exemplary operations for manufacturing an insulated busbar;

FIGS. 2A-2D illustrate various stages of the busbar during the manufacturing process of FIG. 1; and

FIG. 3 illustrates an exemplary system for performing an electrophoreses coating operation of the manufacturing process.

### DETAILED DESCRIPTION

Methods and systems for manufacturing insulated busbars are described below.

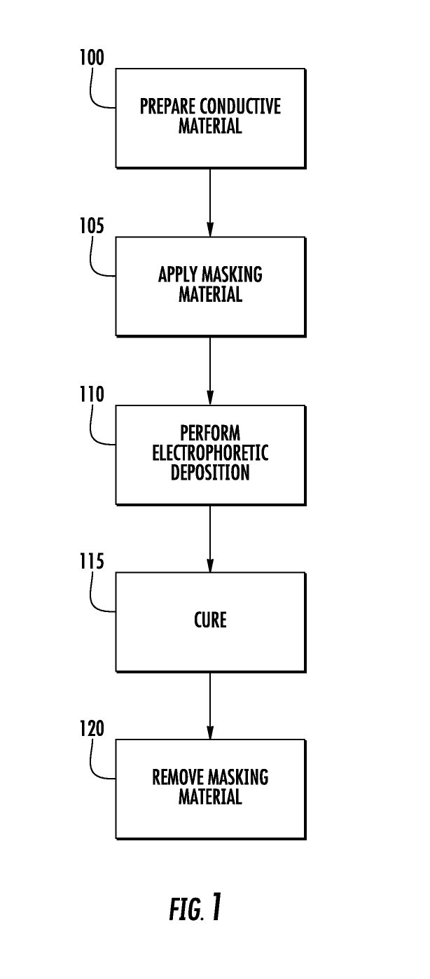

FIG. 1 illustrates exemplary operations for manufacturing an insulated busbar. At block 100, a conductive material may be provided and/or prepared. The conductive material may correspond to copper and its alloys, aluminum, nickel, silver, stainless steel or a different conductive material.

During preparation, the conductive material may be provided in various forms. For example, the conductive material may be provided in a wire form. Wires of various shapes and sizes may be utilized. For example, wire gauges from 0.005 mm and greater may be utilized. Wire widths may be 0.05 mm and greater. The cross-section of the wire may define a polygon having an arbitrary number of sides. The corners may be beveled, rounded, etc.

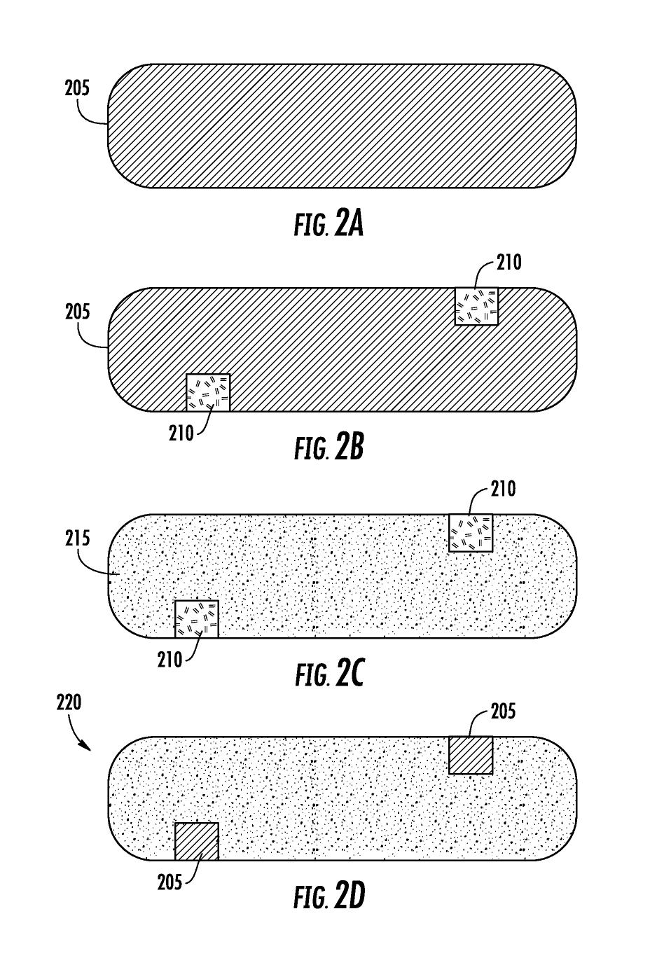

The conductive material may be shaped via various processes into a desired shape such as the conductive bar illustrated in FIG. 2A. After shaping, the conductive material may be hardened or annealed as required. Other bending or forming operations may be performed on the conductive material.

In preparing the conductive material, the conductive material may be cleaned with an organic solvent or detergent to remove any grease. It may be cleaned with acid to remove the oxide layer on the outside surface of the conductive material that may interfere with the electrophoreses coating operation described below. Other pretreatment processes such as surface phosphating may be applied prior to electrophoretic coating.

At block 105, a masking material may be applied to one or more regions of the conductive material to prevent insulating material from being deposited on those regions in subsequent operations. For example, as illustrated in FIG. 2B, masking material 210 may be applied to the surface of the conductive material 205. The masking material 210 may correspond to an electrical insulating material. For example, the masking material 210 may correspond to a photoresist material such as poly(methyl methacrylate), SU-8, poly(methyl glutarimida, phenol formaldehyde resin, a polymer material such as polyethylene, ethylene vinyl acetate, silicone, a dielectric material such as silica, metal oxide, or a different material with similar masking properties.

In some implementations, the solvent referred to above for cleaning the conductive material may be applied after the masking material 210 is applied. In this regard, the masking material 210 may be selected so as not to be affected by the solvent. For example, where the solvent is acid based, the selected masking material may be impervious to acids. Where the solvent is alkali based, the selected masking material may be impervious to alkali-based solvents.

The masking material 210 may be applied via a printing process whereby a printer sprays the masking material 210 through nozzles onto the conductive material 200. In other implementations, the masking material 210 may be applied via a roller saturated with the masking material 210. The masking material 210 may also be applied via mechanical brushing. In yet other implementations, the masking material 210 may be applied via a screening process.

The masking material 210 may be cured after application. For example, the masking material 210 may be air-dried or baked, subjected to UV rays, or an electron beam to cure the masking material. In some implementations, the masking material 210 may be baked at a temperature of 110° C. for 10 minutes to cure the masking material 210.

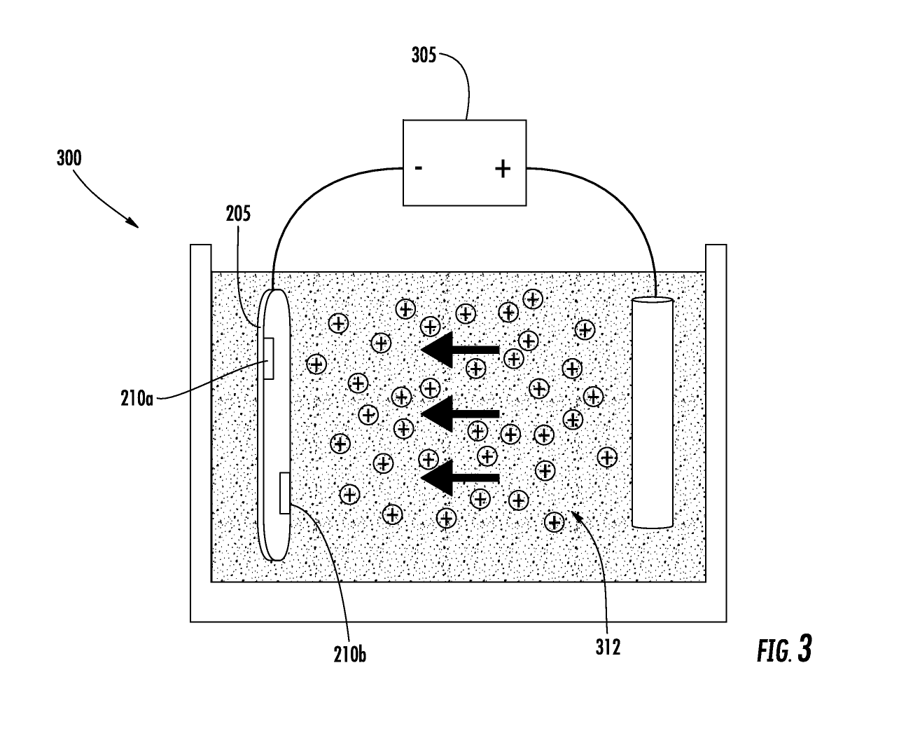

At block 110, the conductive material 205 with the applied and cured masking material 210 may be placed in an insulation deposition chamber, such as the insulation deposition chamber 300 illustrated in FIG. 3. Referring to FIG. 3, the insulation deposition chamber 300 utilizes a cathodic electrodeposition method in which colloidal insulating material particles 312 are suspended in a liquid medium, such as an acrylic-based resin. The medium is coupled to a first polarity of a DC power source 305. The opposite polarity of the DC power source 305 is electrically coupled to the conductive material 205. The DC power source 305 may generate a voltage of about 20-80 Vdc. The insulating material particles 312 in the medium migrate under the influence of the electric field generated by the DC power source 305 to the outside surface of the conductive material 106 to thereby cover any areas of the outside surface of the conductive material 106 that are electrically exposed with the colloidal insulating material particles 312.

The insulating material particles 312 may correspond to any colloidal particles capable of forming a stable suspension, which can carry a charge. For example, the insulating material particles 312 may correspond to various polymers, pigments, dyes, and ceramics. Different materials with similar properties may be utilized.

The process above is capable of producing an insulation layer 215 (FIG. 2C) on the conductive material 205 having a thickness of least 0.014 mm, a leakage current of less than 10 mA, and an insulation resistance of at least 100 MΩ when measured with 500V DC applied across the insulation. In addition, the insulation layer 215 maintains an ISO grade 0 cross-hatch adhesion rating to the conductive material 205 after being exposed to an environment of 60° C. having a relative humidity of 95% for 500 hours, and after temperature cycling one hundred times between −40° C. and 90° C.

Returning to FIG. 1, at block 115, after the desired thickness of insulating material is deposited on the conductive material 205, the coated conductive material 205 is removed from the deposition chamber 300 and then subjected to a curing process. As illustrated in FIG. 2C, upon removal from the deposition chamber 300, an insulation layer 215 is formed on all regions of the conductive material 205 except for those regions covered by the masking material 210.

During curing, heat may be applied to the insulated conductive material to accelerate the removal of any solvents present in the colloidal insulating material particles of the insulation layer 215. The heat may also cause the colloidal insulating material particles of the insulation layer 215 to disperse evenly around the outside surface of the conductive material 205, to thereby form a lasting bond between the insulation layer 215 and the conductive material 205. The heat may also cause chemical crosslinking of the insulation layer to have better stability. In one implementation, the insulated conductive material may be heated to a temperature of about 180° C. for a period of 30 minutes.

At block 120, the masking material 210 may be removed to expose one or more regions of conductive material 205, as illustrated in FIG. 2D. In one implementation, a solvent different from the solvent utilized above for preparing the conductive material such as dilute sulfuric acid may be utilized. For example, where the solvent used for cleaning the conductive material is acid based, the solvent used for removal of the masking material may correspond to an alkali-based solvent, and vise versa.

As shown, the implementations described above facilitate preparation of insulated bus bars with complex shapes for which insulation would be difficult if not impossible to remove using the conventional means described above.

While the method for manufacturing the insulated busbar has been described with reference to certain embodiments, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. For example, the operations described above may be applied equally well to pre-cut conductive material sections and/or assemblies of pre-cut conductive material sections, which may be welded together to provide an assembly of conductive sections, prior to forming an insulating later over the conductive material. Therefore, the claims should not be construed as being limited to any one of the particular embodiments disclosed, but to any embodiments that fall within the scope of the claims.

1. A method for manufacturing an insulated conductive material, the method comprising:
applying a masking material to one or more regions of a conductive material via at least one of brushing, rolling, and screening the masking material onto the one or more regions of conductive material; and
coating regions of the conductive material other than the one or more regions with an insulating material by:
electrically charging the conductive material with a first charge polarity;
providing a medium of electrically charged insulating material particles that are charged with an opposite polarity;
passing the charged conductive material through the medium to bind the insulating material particles bind areas of the conductive material other than the one or more regions;
curing the bound insulating material particles; and
applying a solvent to the masking material to thereby remove the masking material, wherein the cured insulated material particles are substantially unaffected by the solvent.

2. The method according to claim 1, wherein the medium of electrically charged insulating material includes insulating colloidal particles suspended in a liquid medium.

3. The method according to claim 1, wherein the conductive material includes at least one of copper, a copper alloy, aluminum, nickel silver, and stainless steel.

4. The method according to claim 1, wherein the masking material is an electrically insulating material.

5. The method according to claim 4, wherein the masking material includes at least one of a photoresist material, a polymer material, and a dielectric material.

6. The method according to claim 1, further comprising baking the conductive material and the applied masking material before coating the conductive material with the insulating material to thereby cure the masking material.

7. The method according to claim 1, further comprising applying a second solvent to the conductive material after applying the masking material to thereby remove surface oxidation from the conductive material, wherein the masking material is substantially unaffected by the second solvent.

8. The method according to claim 1, wherein the insulating material includes a mixture of one or more of epoxy, epoxy/polyester hybrid, polyester, acrylic resin, and polyurethane base resins.

9. The method according to claim 1, wherein the conductive material corresponds to a pre-shaped wire.

10. The method according to claim 9, further comprising coining the wire prior to applying the masking material.

11. The method according to claim 9, further comprising bending the wire into a desired shape prior to applying the masking material.

12.-14. (canceled)
